(19) United States
(12) Patent Application Publication
(10) Pub. No.: US 2002/0169667 A1
(43) Pub. Date: Nov. 14, 2002

(54) Content submission and distribution system for use in clearing advertisement spots

(76) Inventors: Leonard Marotta, Richmond, CA (US); Robert Hall Howard, Coppell, TX (US); Stephen E. Beard, Walnut Creek, CA (US); Mahesh Kheny, Pleasanton, CA (US)

Correspondence Address: POLIT & ASSOCIATES, L.L.C., 3333 WARRENVILLE ROAD, SUITE 520, LISLE, IL, 60532, US

(21) Appl. No.: 10/063,040

(22) Filed: Mar. 14, 2002

Related U.S. Application Data
(60) Provisional application No. 60/275,558, filed on Mar. 13, 2001.

(51) Int. Cl. G06F 17/60

(52) U.S. Cl. 705/14

(57) ABSTRACT

An automated media content submission and distribution network for use in clearing network advertisements, such as those for television networks, is set forth. The network includes a job submission system disposed at a submitting organization that allows a user to submit a clearance job for an advertising spot, a job access system disposed at a clearance organization involved in clearing the network advertisements, and a host system that includes a content management system that is adapted to receive digital job content from the job submission system and to provide the clearance organization with access to the digital job content through the job access system. In accordance with one embodiment of the network, the identification of users who are to have access to the digital job content is defined in the clearance job and used by the host system to grant such identified users secured access to the digital job content. The system may be in the form of an Internet based client/server system.

### CROSS REFERENCE TO RELATED APPLICATIONS

The present application is a non-provisional application based on U.S. Ser. No. 60/275,558, filed Mar. 13, 2001, entitled “Content Submission System and Method of Use and Doing Business”, and USSN_(Corporate Docket No. SGUS00018), filed Apr. 5, 2001, also entitled “Content Submission System and Method of Use and Doing Business”. The content of these provisional applications is hereby incorporated by reference in their entirety.

### BACKGROUND OF INVENTION

The advertising clearance process ensures that the advertising spots that agencies create for their advertisers meet the standards imposed by the Agency's Network Clearance Department, the advertiser's Legal Counsel or representative, and the Network's Advertising Standards Department. The production and clearance of such advertising spots for television is labor intensive and typically involves a substantial number of different organizations. For example, the clearance process often involves the following individuals and organizations: Account Executives: These are the individuals who manage and represent the advertising clients and campaigns on behalf of the advertising agency. They initiate orders for legal and network clearance and release masters and supporting documentation.

Postproduction House: This organization edits the completed spot and often produces ¾″ tape cassettes of the completed spot as requested by the advertising agency.

Legal: This organization is normally a 3^{rd}-party law firm. Legal receives storyboards, scripts, affidavits, and/or spots from the Network Clearance Department for review/approval.

Network Clearance Department: This is a department within the advertising agency that reviews and processes all new television spots intended for distribution on national television. This group is typically the interface between the Account Executive, Legal, and the television networks.

Advertising Standards Department: This group operates within the television network and reviews advertising spots for network broadcast.

Editors: These individuals are the advertising spot reviewers in the Network's Advertising Standards Department.

Because it involves so many organizations and individuals, the clearance process typically starts well before new advertising spots go into the production phase. Before production, storyboards and scripts are written, reviewed, and are subject to a pre-approval process. During this process, affidavits are often provided to substantiate advertising claims made on behalf of the product and are frequently provided with the scripts and storyboards. In the pre-approval process, the storyboards, affidavits, and scripts are often forwarded by the Agency's Account Executives to the Agency's Network Clearance Department, where, after review by the Agency's Network Clearance Department, the items are forwarded by courier to Legal Counsel and/or to the Network's Advertising Standards Department. In many cases Legal Counsel is a third-party firm representing various advertisers and brands handled by that particular agency. Once the items have been reviewed by Legal Counsel and Advertising Standards Department, comments are returned to the Agency's Network Clearance Department by courier and processed accordingly.

Once the storyboards and scripts have been approved, the Advertising Agency produces the advertising spot. Typically, videotaping of the advertising spot takes place at a Studio, such as a television studio, while final editing and processing of the spot takes place at a Post-Production House.

After final editing at the Post-Production House, the Post-Production House typically makes ¾″ cassettes of the final version of the advertising spot for use in obtaining network clearance for it. The cassettes are generally provided by courier to the Account Executive or directly to the Agency's Network Clearance Department. The produced advertising spot is then reviewed by the Network Clearance Department and subsequently forwarded by courier to Legal Counsel and/or to the Network's Advertising Standards Department for their review, comment, and approval. Notification of approval or rejection by Legal Counsel and the Advertising Standards Department is returned to the Agency's Network Clearance Department, typically by courier.

The foregoing steps used in the pre-clearance and final clearance of advertising spots has, until now, involved a substantial number of dissociated communication mediums and methods that have, in turn, resulted in duplicative work and inefficient pre- and post-production delays. Such problems are particularly pronounced in large advertising agencies and large television networks that concurrently handle the clearance and approval of large numbers of advertising spots. However, the present inventors have recognized a need in the advertising industry for an automated system and corresponding business method that can be used to effectively and efficiently manage the process and communications that ultimately lead to the clearance of advertising spots.

### SUMMARY OF INVENTION

An automated media content submission and distribution network for use in clearing network advertisements, such as those for television networks, is set forth. The network includes a job submission system disposed at a submitting organization that allows a user to submit a clearance job for an advertising spot. The clearance job typically includes digital job content corresponding to one or more items selected from the group consisting of advertising substantiation documentation, advertising scripts, advertising storyboards, pre-production advertising media (i.e., video), post-production advertising media (i.e., video), and client job messages. The clearance job materials may include pre-production materials and/or post-production materials and need not include all materials needed for completion of the clearance job in a single order transaction.

The network also includes a job access system disposed at a clearance organization involved in clearing the network advertisements. The job access system includes software that may be used by a user at the clearance organization for reviewing digital content of the type submitted by the job submission system.

A host system is also included as part of the overall network and includes a content management system that is adapted to receive the digital job content from the job submission system and to provide the clearance organization with access to the digital job content through the job access system. In accordance with one embodiment of the network, the identification of users who are to have access to the digital job content is defined in the clearance job and used by the host system to grant such identified users secured access to the digital job content.

### BRIEF DESCRIPTION OF DRAWINGS

FIG. 1 is a diagram of a submission and clearance system constructed in accordance with one embodiment of the present invention.

FIG. 2 is an illustration of one embodiment of an organizational hierarchy of the submission and clearance system of FIG. 1 from a data administration perspective.

FIG. 3 illustrates one embodiment of a login screen that may be used in a user interface of the system shown in FIG. 1.

FIG. 4 illustrates one embodiment of an administrator screen that may be used in a user interface of the system shown in FIG. 1.

FIG. 5 illustrates one embodiment of a user group screen that may be used in a user interface of the system shown in FIG. 1.

FIG. 6 illustrates one embodiment of a new user group screen that may be used in a user interface of the system shown in FIG. 1.

FIG. 7 illustrates one embodiment of a user information screen that may be used in a user interface of the system shown in FIG. 1.

### DETAILED DESCRIPTION

Although the system and business method set forth below is described in the context of a system for clearing video advertisement spots that are to be aired on one or more television networks, it will be recognized that the system and business method may be extended to the clearing of various types of media. For example, the illustrated system may be extended to use and audio spots for radio networks, major national commercial campaigns, etc.

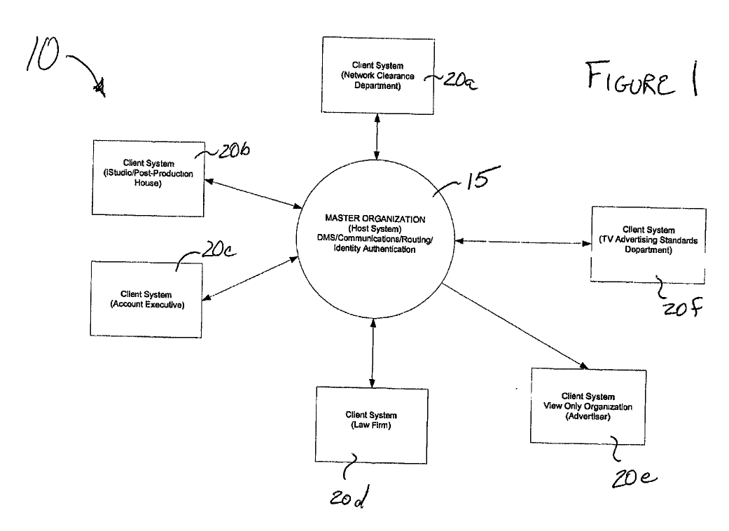

A diagram of one embodiment of the submission and clearance system is shown generally at 10 of FIG. 1. As illustrated, the system 10 includes a host system 15 that is in electronic communication with one or more client systems 20a-20f over a network. The communication network may take on any of a variety of different forms including, but not limited to, LANs, VPN's, WAN's, etc. In the embodiment set forth here, the host system 15 and the client systems 20a-20f are connected for communication over the Internet. In this manner, the host system 15 may be designed to include the database management software, automatic communications software, message and media routing software, identity verification software, etc., used to execute the various functions associated with the host system 15 (described more fully below). In contrast, the client systems 20a-20f may interact with the host system 15 through a standard Internet browser that is capable of executing JAVA applets. As such, the client systems 20a-20f can readily have their functions implemented using standard applications thereby allowing easy setup of new users and client systems.

Generally stated, the client systems 20a-20f and includes at least one system that is capable of cooperating with host system 15 in a job submission mode of operation and at least one further system that is capable of cooperating with host system 15 in a job access mode of operation. Although the following discussion may make a distinction between the systems 20a-20f that implement these operational modes, it will be recognized that a single client system 20a-20f may cooperate with the host system 15 in either operational mode at different times. For example, the host system 15 may be responsible for downloading either job submission applets and/or job access applets to a given client system 20a-20f based on user commands and/or information provided through the given client system.

For purposes of the following example, it is assumed that client system 20a is disposed at an advertising agency and operated by a Project Coordinator in the Network Clearance Department who must obtain clearance for an advertising spot. The Project Coordinator uses the client system 20a to place it in the job submission mode of operation thereby allowing submission of a clearance job for distribution to organizations within the system 10. To this end, the Project Coordinator uses the client system 20a to select the organizations that are to have access to the digital job content and/or receive notification of the existence of the clearance job. One such selected organization may be, for example, the Network's Advertising Standards Department, which, in the present example, is the site of client system 20f.

The clearance job may include digital job content corresponding to a variety of advertising material types in need of review and/or approval by others before further action may be taken on the advertising spot. For example, the, clearance job materials may include pre-production materials and/or post-production materials and may, but need not, include all materials needed for completion of the clearance job in a single order. Such advertising material may include one or more pieces of material selected from the group of advertising substantiation documentation, advertising scripts, advertising storyboards, pre-production advertising video and/or audio, post-production advertising video and/or audio, agency cover letters, legal cover letters, legal forms and client job messages.

Advertising video and/or audio may be provided as part of the clearance job in a number of manners. For example, client system 20b may be provided at a Studio/Post-Production House that has the capability of converting the advertising video to, for example, MPEG 2 format. The converted video may then be uploaded to the host system 15 for storage. In such instances, the clearance job submitted by the Network Clearance Department through client system 20a may include links to the converted video and/or audio files for access by the selected organizations. In other instances, the converted file may be uploaded directly to the Network Clearance Department through the host system 15 and later included as part of the clearance job. Still further, the advertising video cassettes may be sent directly to the Master Organization (the organization managing and/or operating the host system 15) for conversion and storage on either the host system 15 or client system 20a. In this last example, the Master Organization may provide the conversion services for a fee and include the fee on the invoices sent to the Billing Organization (see below).

Another client system, such as client system 20f, cooperates with the host system 15 to function in a job access mode of operation. In this example, client system 20f is disposed at the Network's Advertising Standards Department or other organization involved in clearing the television network advertisement spots. Client system 20f includes software viewers for viewing digital content of the type submitted by the job submission system. For example, client system 20f may include software for viewing MPEG encoded video files (downloading or streamed from the source) as well as other software for viewing scripts, storyboards, affidavits, etc.

The host system 15 mediates most, if not all, of the communications between the users of system 10. It may be comprised of one or more servers that are connected to, for example, the Internet through one or more routers.

The host system 15 includes a content management system that is adapted to receive the digital job content from client system 20a (or, with respect to media content, through any of the means described above) and to optionally notify client system 20f of the existence of the clearance job. The Network's Advertising Standards Department may then use the client system 20f to access the content of the clearance job and, if required, provide their comments, approval, denial, etc. Such comments, approval, denial, etc., by the network's advertising standards department may then be communicated to client system 20a through the host system 15 and reviewed by the Project Coordinator or another network clearance department manager through an appropriate user interface screen or the like.

Host system 15 may also provide additional tools to each of the organizations operating the client systems 20a-20f. For example, various users initiating and/or receiving clearance job materials should be able to check on the status of the job and its routing. To this end, host system 15 may provide status and/or report information to one or more authorized users at the client systems 20a-20f through an appropriate user interface screen or the like. Such reporting data may include, for example, a) ISCI/Filename, b) Order Number, c) Title of spot, d) Brand/Advertiser of order, e) Customer submitting spot, f) Order entry date, g) Status of order. Reporting data may be maintained by the host system 15 for an unlimited period of time or for a predetermined period of time from initial entry.

An order status interface for tracking and monitoring orders may also be provided on the client systems 20a-20f. The order status interface may show the order history, with the routes the order has taken, the status and dates for each of the routes, and the users and groups involved with the order. “Waiting for media” may also be used as an order status property in those instances in which the transition to the next order route is blocked until the media has arrived. First, this status may be used when an order with a media attachment is waiting for the media to physically reside on the host system 15 before it is routed. When the media arrives and the association is made by the host system 15 to the order that refers to it, the order is ready for further routing. Second, this status may be used to block download of the media when an order with media is routed to an organization that has requested download of the media. The download is blocked until the media is sent and arrives.

Further, host system 15 may provide search functions that may be used by authorized users at the client systems 20a-20f to locate specific jobs within the system 10 for reporting, status checking, modification, etc. Preferably, orders may be searchable on reporting data.

In those instances in which the services of the host system 15 are offered for a fee, host system 15 may include a billing/invoicing system. Further, host system 15 may include an audit system that keeps track of each transaction between a client system 20a-20f and the host system 15. The information acquired by these systems may optionally be made available to an organization through the reporting system discussed above.

FIG. 1 shows a number of different organization types using the client systems 20. The types of organizations that will typically be associated with the system 10 include advertising agencies, advertising agency network clearance departments, law firms or departments, studios, advertisers and network advertising standards departments. The system 10, however, may assign one or more of the foregoing organization types to a particular organization category that effectively defines and limits the interaction that the particular organization may have in the overall clearance process through the client systems 20a-20f. For example, the host system 15 may be used to assign one of the following organization categories to a particular organization and thereby grant or deny various system rights:Master Organization This is the organization where the host system 15 resides and is maintained. A Master Organization has all the privileges given under the overall system 10, and is responsible for creating new organizations. Multiple Master Organizations may be used to provide for use of multiple systems 10 and regionalization of those systems. Typically, the Master Organization provides the services of system 10 for a fee to a Billable Organization (below).

Billable Organization This is an organization that is the billed entity within the system 10. This organization may have billing forwarded to another Billable Organization. All clearance jobs, as well as orders containing multiple clearance jobs, originate at Billable Organizations. Agencies and Advertisers are typically categorized as Billable Organizations.

Regular Organization This is an entity that has orders routed to it, for approval or view-only purposes. Legal Counsel and Departments as well as Network Advertising Standards Departments are typically categorized as Regular Organizations. Offline Organizations (see below) that fall under Regular Organizations will require manual order routing.

Offline Organization This is an organization that is not part of the overall electronic submission and clearance system 10, but is shipped media for review outside of the system 10. That is, an Offline Organization is created in system 10 for routing of media, but there are no users or groups for that organization. When a job order includes an Offline Organization that is to receive the submission, the Offline Organization data (i.e., address, fax number, etc.) can be routed back to the Billable Organization or to the Master Organization to thereby arrange for the submission to be sent to the Offline Organization outside of the system 10 (i.e., by courier).

Online Organization This is an organization that is part of the system 10. Online Organizations are typically comprised of users and groups setup for participating in the submission, review and/or clearance process, but may include users and groups who are part of View Only Organizations.

Bill-Only Organization A Billable Organization that is part of the system 10, but only in a support role. There are no users or groups for these organizations. For example, agencies and advertisers can be assigned to the Bill-Only Organizations category.

Business Partners A list of Regular Organizations that have been selected by a Billable Organization for possible order routing or for producing content for the submission and/or clearance process. When an order is ready to route for approval, one or more Business Partners may be selected from the Business Partners list to receive the order.

View Only Organization A Regular Organization that does not have approval rights for orders.

In addition to the foregoing organization types, users of the system 10 may be categorized in a manner that grants or denies certain system rights to the individual user within the organization. For example, the host system 15 may classify users into one or more of the following categories:Master Administrator This is an administrator within a Master Organization who has all rights and privileges for setting up and modifying all parameters within the entire system 10. For example, a master administrator may set up, categorize and modify organizations as well as set up and modify Organization Administrators within each organization.

Organization Administrator This is a user within an organization that has administrator privileges. This administrator sets up users and groups within their organization.

Administrator Group This is a group that is defined within an organization. Users who are members of an Administrator Group have administrator privileges within that organization.

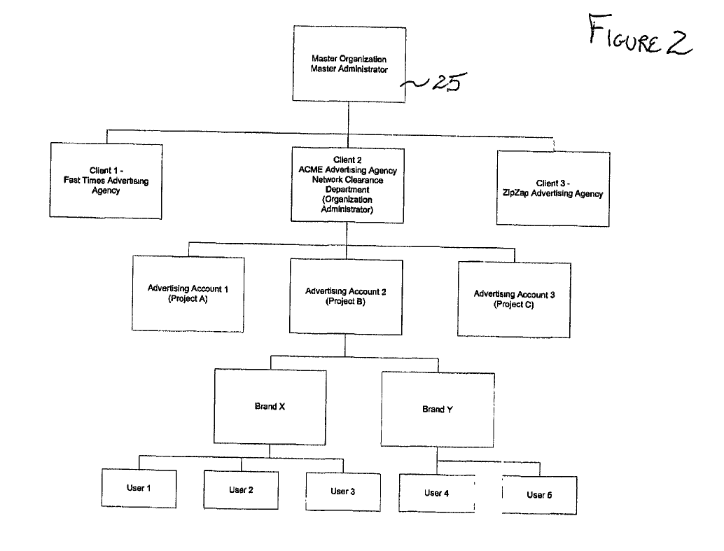

FIG. 2 illustrates one example of an organizational hierarchy of the submission and clearance system 10 from a data administration perspective. This organizational hierarchy is preferably defined and implemented within the host system 15. As illustrated, the Master Administrator 25 of the Master Organization is at the top of the organizational hierarchy and can execute all administrative tasks associated with establishing and maintaining organizations and organization administrators. Beneath the Master Administrator 25 there is a plurality of client organizations, shown here as Clients 1, 2 and 3, that each have at least one Organization Administrator established by the Master Administrator 25. In the illustrated embodiment, Clients 1, 2 and 3 correspond to three different advertising agencies. However, only the ACME Advertising Agency (Client 2) is expanded in further detail.

Within the ACME Advertising Agency, there is a Network Clearance Department having at least one Organization Administrator that executes all of the administrative tasks associated with the accounts serviced by the ACME Advertising Agency. Each billable client, however, may have one or more Project Coordinators with various administrator rights. The Project Coordinator is responsible for setting up the group of users, their access privileges, and the workflow for a particular project by using the software management tools provided to them through, for example, host system 15. The Project Coordinator thus has the ability to set and use pre-stored parameters for the efficient processing of network/legal clearance projects. In most cases the individual managing or coordinating a project or job will be someone in the Network Clearance Department of the agency, as illustrated in FIG. 2. In the illustration, three advertising accounts are shown. However, only Advertising Account 2 is expanded in further detail for the sake of simplicity.

In the illustrated embodiment, Project B has been opened by the Organization Administrator or Project Coordinator in connection with Advertising Account 2. Project B includes the various clearance jobs associated with the clearance of advertising spots for Brand X and Brand Y. In turn, the Organization Administrator or Project Coordinator has given Users 1, 2 and 3 privileges associated with the clearance of Brand X jobs while Users 4 and 5 have been given privileges associated with the clearance of Brand Y jobs.

As apparent from the foregoing example, the submission and clearance system 10 may be used by advertising agencies having multiple accounts (i.e., advertisers) and multiple brands that are often managed by different Account Executives working for that agency. Although most agencies have only one Network Clearance Department, an advertiser, brand, or job may have different requirements with respect to clearance and workflow. As such, the advertising accounts and/or brand accounts of FIG. 2 may each have a number of different “projects” associated with them. To this end, a “project” may be defined as one or more jobs associated with either an advertiser or a brand as managed by the advertising agency. An agency may thus have one or more projects depending on workflow, clients, brands, and other requirements that may be unique to a set of jobs. If the system 10 is to allow a given advertising agency to support multiple projects, then the organizational hierarchy may be include support for multiple Project Coordinators or multiple network clearance department managers at the Given agency.

Project Coordinators should have organization administrator privileges since they are responsible for orders being processed through the submission and clearance system 10 by their organization. The Project Coordinator handles the workflow by, among other things, choosing routing for an order. As such, the Project Coordinator may be given the responsibility of setting up groups of users, their access privileges, and the workflow for a project. Further, a Project Coordinator should have access to reporting, monitoring and tracking data associated with an order. When the Project Coordinator determines all routing for an order is complete, the order can be closed using the management tools provided through the host system 15. The Project Coordinator should also be able to cancel orders that “hang” when they cannot be routed to the next organization, for example, when waiting for media or when orders are declined.

Only users with order creation rights can create orders. This capability is only available within a Billable Organization (i.e., agency) and the Organization Administrator is the individual that enables this creation right for a particular user or user group.

An order that includes a clearance job may be submitted in a variety of ways through the client systems 20a-20f and may include various types of information. Generally stated, one way in which a clearance job can be organized is through the use of metadata fields and advertising material attachments. quickmarkquickmarkAdvertising substantiation documentation, advertising scripts, advertising storyboards, pre-production advertising video and/or audio, post-production advertising video and/or audio, agency cover letters, legal cover letters, legal forms and client job messages may be submitted as attachments. For media attachments, a metadata definition user interface may be provided on a project level to allow the Organization Administrator and/or Project Coordinator to define the metadata field labels that are to appear on the order. At least six fields are typically recommended. They include: a) ISCI or filename, b) Title, c) Advertiser and/or brand, d) Agency, e) Date Entered, and f) Preview. “Preview” stands for preview quality media (MPEG1). “Preview” will have a value of “true” for preview quality media, and a value of “false” for broadcast quality media (MPEG2).

The remaining fields are optional. For example, a number of customer-defined metadata fields may be provided to support queries and provide descriptive information for each advertising spot.

When an order is created, existing project information, such as advertiser, project name, and definitions may populate the order fields of the user interface where appropriate. An attachment section of the order identifies the attachments that are to go with the order. The user interface should provide an easy means through which such attachments can be identified and located. Routing for the order is also assigned by the billable organization. The order is routed to the Inbox of one or more specific organizations and attachments are routed to the Inbox on an organization basis.

Orders are typically routed to a group inbox. Orders not routed to a specific group inbox may be automatically routed to a default group inbox data is set up by the Project Coordinator or other individual with administrator privileges. Email notification may go to all users assigned to the group inbox where the order gets routed. However, an organization receiving the routed order may have a specific user assigned by the Project Coordinator (through a user interface and to the corresponding client system) to take ownership of orders within a specific group. In that case, only that user will receive the email notification. Once received, orders can also be moved from the general inbox or the user's personal inbox to another user's personal inbox and vice versa.

Users may claim orders by selecting an unassigned order in their inbox. Filters may be provided to allow users to more easily select orders for view. Filters on orders, attachments, and routing may be provided. Filtering on orders may allow users to see all orders if desired.

Routing is determined per destination and is not necessarily the same for all destinations. For example, a Project Coordinator may initially set a route to Legal and submit the order to them. The order approval may then be sent back to the Project Coordinator. The Project Coordinator may then route the order to three networks, but could decide to route another version of the media to one of the networks.

The digital job data associated with each order, as noted above, may be comprised of one or more attachments, as well as the metadata describing the advertising spot. Any attached media is preferably in the form of MPEG1 and/or MPEG2 encoded files. The system 10 may also include support for streaming media and download of media, the choice being user selectable through an appropriate user interface presented at the client system. Icons may be presented to the user through the browser interface to identify each attachment as well as the type of attachment (i.e., document, video, etc.). Further, comment/note fields containing information entered by the job initiator may appear beside each attachment. Attachment version data may also be presented to the user. Organizations reviewing orders may also add attachments.

MPEG encoded spots are preferably loaded onto the submission and clearance system 10 using a secure file upload utility. Only users with access rights granted by the Project Coordinator or Organization Administrator can add media files and attachments to an order. Uploaded spots may include the following information: 1) ISCI/Filename, 2) Advertiser/Brand, and 3) Title of spot, to allow automatic matching to an existing order. When the media is received, it is automatically associated with an order and email notification is sent to the project coordinator indicating the fact that the order is ready for processing. Once media has been matched to media attachments, the status of the order will go from a “Waiting for media” state to a “complete” state. This makes the order available for routing to other organizations.

Users set up by the Organization Administrator or other person with administrator privileges may have access to user profile tools. A user may use the profile tools to change their password and email address. The user can also use the profile tools to select or deselect whether they will receive email notification when an order directed to their user group is received.

Advertising standards departments and legal organizations have unique roles that require the implementation of special functions by system 10. For example, to expedite processing within each of these organizations, the order may include data providing the user with an indication of the order type. To this end, orders may be categorized as: a) New order, b) Resubmitted order, or c) Preliminary Approval Requested order (video spot is not attached). This information can be used by the receiving organization to allocate time and resources for the job.

Often, organizations need to add comments to a job. This function may be executed through a comment text dialog interface that is associated with the order and presented to the user through, for example, their web browser. Further, advertising standards departments and legal users may add new attachments and new versions of those attachments as a response to the order. For example, they may attach and/or replace a cover letter for delivery back to the network clearance department or provide red-lined versions of the attachments that were sent to them. Still further, the order screen may be provided with buttons for selection of Approved/Declined/Declined Pending Info.

The submission and clearance system 10 includes data archiving and removal features to ensure system efficiency. To this end, inactive orders that have been closed or canceled are automatically archived after 90 days. This option may be selected by the user on the project level. Media may be left online, or taken offline by archiving or deleted based on a user selected time period. Other attachments and metadata have the same options for archiving/deleting at the order level.

System 10 may also include a search utility that is accessible to a user at the client system through, for example, a web page. Users, for example, may have search capabilities at the Inbox level. Search filters may include by order (status (active or inactive), state, creator, creation date, etc.), by attachments (type, document extension, attach date, etc.), by metadata (system-defined), and by routing (date, status, etc.). Location of the desired information may be based on a general keyword search against all data representing every record the user has access to, and/or a keyword search against system-defined metadata fields. The search results may be sortable by date, title, advertiser, brand, or agency as well as by individual columns of the search results table.

The Master Organization of FIG. 1 typically provides the automated submission and clearance system services for a fee. Accordingly, system 10 is provided with a usage tracking utility to support customer billing, billing detail and backup. The usage tracking data, in turn, is provided to an automated billing system that calculates the sums owed to the Master Organization. Billing rates can be both transaction-based and storage-based. Further, the Master Organization may charge fees for each video spot that it encodes, uploads and processes. The billing system may also generate the appropriate billing logs to support both manual billing and Great Planes-based billing.

As noted above, the various functions described above can be implemented in the context of a web-server/client environment in which the host system 15 operates as the web-server while client systems 20a-20b operate in a client mode. Users of the system 10 may thus enter data and select options that implement the functions described above through the web pages that serve as the user interface. Details of specific implementations of several such web pages are illustrated here in connection with a series of browser screens that allow a user within an organization to interact with the host system 15.

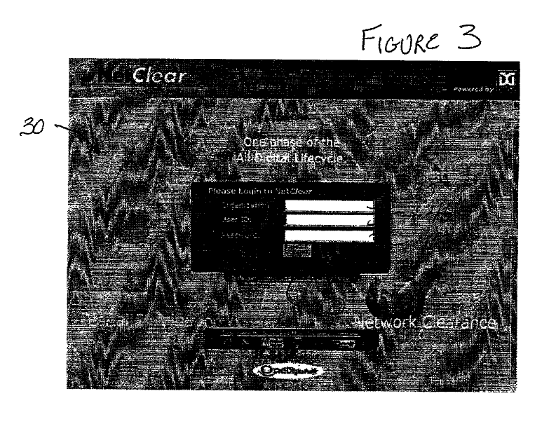

As illustrated in FIG. 3, a user is first confronted with a login screen, shown generally at 30, that must be filled in which the appropriate data before the user can access further features of the system. The login screen 30 includes an organization field 35 to allow the user to identify the organization of which he is a part, a user field 40 to identify the particular user that is attempting to access the system, and a password field 40 that allows the user to provide his password for authentication. The organization identification number that is to be entered in the organization field 35 is typically obtained from the master organization once the master administrator has set up the organization's account. The information entered into these fields by the user is sent to the host system 15 for identification and verification. This information is also used by the host system 15 to set the access privileges for the user for the session.

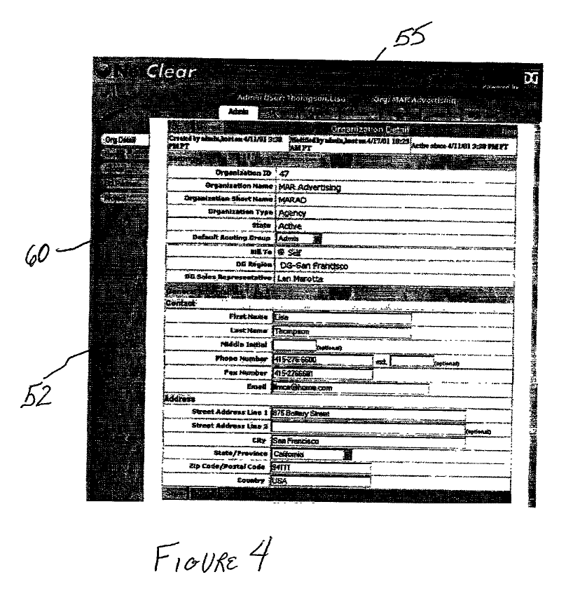

Upon successful login, the user will be provided with a navigation screen such as the one illustrated in FIG. 4. The navigation screen 52 gives access to the system functions that are available to the user. The system functions will typically depend on whether the user has administrator privileges. When the user has such administrator privileges, many additional fields and buttons are provided to allow the user to set up users, user groups, projects, business partners, etc.

In the illustrated embodiment, the web browser includes a navigation screen 52 having two frames. The top frame may be in the form of a functional navigation frame 55 having a plurality of tabs that can be activated by the user to access the identified function. The left frame may be in the form of a sub-selection navigation frame 60 that includes a plurality of tabs that may be activated by the user to access specific screens associated with the functions selected from the functional navigation frame 55. The functional navigation frame 55 may be common to all users and is available so long as the user is logged into the system 10. The sub-selections that are actually available to the user, however, will depend on the rights of the user as defined by the organization administrator in the host system 15. A master administrator will have access to all available selections. As shown, the functional navigation frame 55 of the illustrated embodiment includes the following functions: 1) Admin, 2) Orders, 3) Search, 4) Folder, 5) Reports, 6) Contact and 7) Sign out. For the Admin function, the following sub-selections are presented to the user in the sub-selection navigation frame 60: 1) Org Detail, 2) User, 3) Group, 4) Biz Partner, and 5) Project.

FIG. 4 illustrates a screen that has been accessed by a user through activation of the Admin tab in the functional navigation frame 55 and the Org Detail tab in the sub-selection navigation frame 60. This screen provides an Organization Administrator with basic organization account details as set up by a Master Administrator. The basic account information may include the organization identification number, the organization name, the organization type, the master organization region, organization contact information, etc.

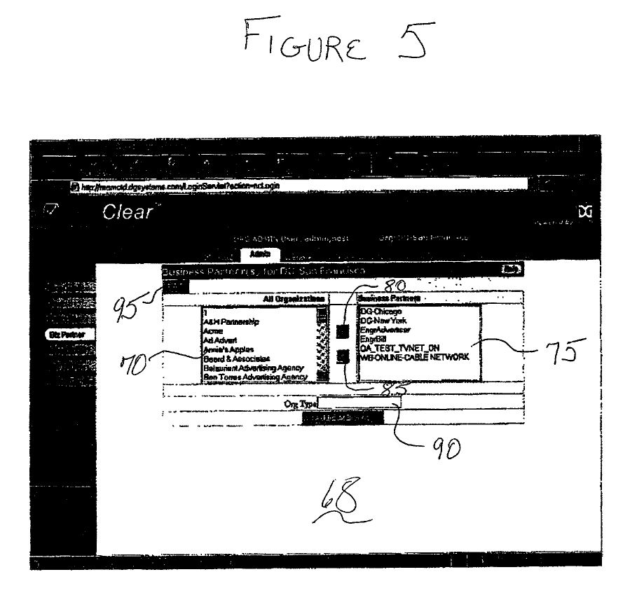

The sub-selection navigation frame of FIG. 4 also includes a “Biz Partner” tab that is used to access the “Business Partners” screen 68 of FIG. 5. The “Business Partners” screen 68 lets online Billable Organizations select the various organizations with whom the other users in the organization are authorized to work with. As illustrated, the left column 70 displays all organizations having an account with the Master Organization. The right column 75 displays the organizations that have been selected by the Organization Administrator to work with the organization. Buttons 80 and 85 allow the Organization Administrator to add and remove organizations from the right column 75. The particular organization type that is to be assigned to a given organization appearing in the right column 75 may be entered into field 90.

The right column 75 serves as the list of possible routing organizations the Billable Organization can use to route orders. If a Billable Organization needs to work with an organization that is not in the left column 70, they can navigate to the Organization function 95 that, in turn, will present the user with a screen to enter information for the new organization. The Master Administrator will then be automatically contacted by, for example, e-mail to have the organization added to the submission and clearance system 10.

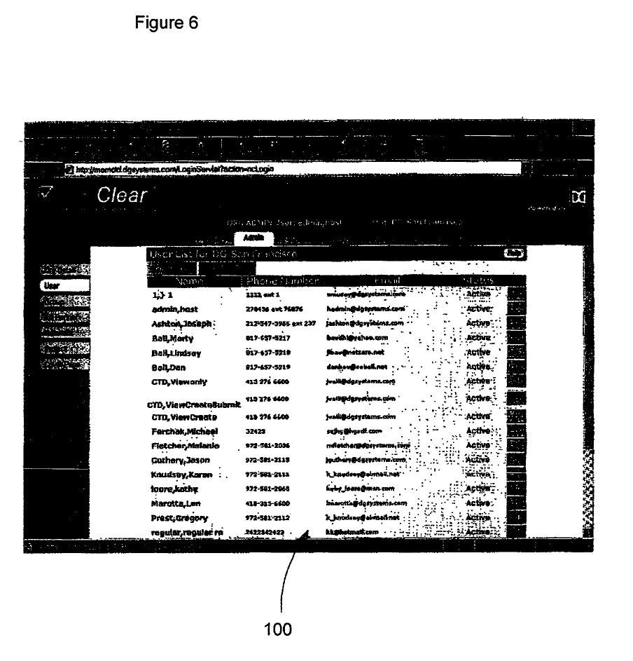

Selection of the “Group” tab from the functional navigation frame 55 reveals the group screen shown generally at 100 of FIG. 6. The group screen 100 allows organization administrators the ability to group their organization users. Orders can be routed to specific groups or a default group. Maintenance for groups, such as adding more users to a group or adding a new group, may also be performed through this screen and through web pages linked to this screen. To modify an existing group, the user activates the “Edit” button. To create a new group, the user activates the “New Group” button. Activation of the “New Group” button may present the user with a New Group screen in which a list of all organization users is provided in a first column opposites a list of selected users in a second column that have been selected to be members of the new group. Further, the screen may provides a job submission selection area that allows the user to determine whether jobs are routed to all members of the group or to a single group member, identified from a pull-down menu.

Master Administrators should also be provided with some manner of selecting the organization to which the user groups that are to be viewed belong. This is true of all screens that are available to the Master Administrators. Each Master Administrator screen should have an organization selection drop-down box or the like to allow the Master Administrator to select the organization that is to be viewed and/or edited.

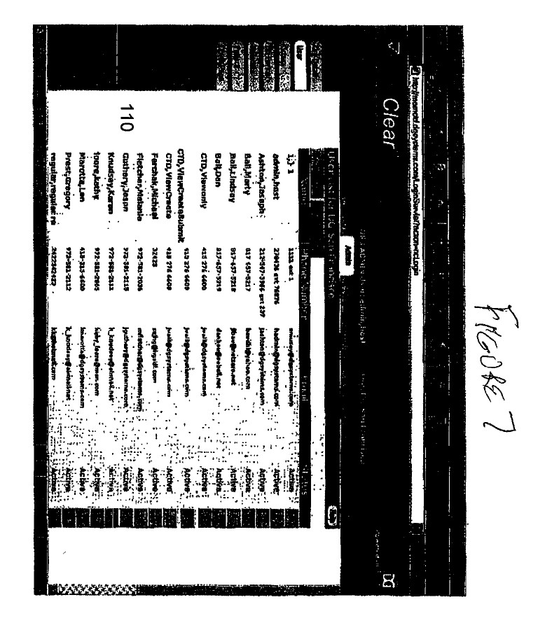

Activation of the “User” tab presents the user screen, shown generally at 110 of FIG. 7. The user screen 110 is used by the Organization Administrator to create, modify, and delete users of an organization. Regular users will see a variation of this screen where only the “Password”, “Re-Type Password”, “Email”, contact info, and “Turn off email notification” are modifiable.

A projects screen may also be presented to a user who hands and administrator privileges. The projects screen may allow an online Billable Organization to create and maintain projects and should only accessible by master administrators and online Billable Organization users that have order creation rights. Various fields used to characterize a project may be filled in by the user. For example, a field may be used to identify the industry to which the project belongs. Other fields may be used to select an advertiser for the project as well as the brand to which the project pertains. Still further, the page may include a section for selecting what happens to the order after disclosed. For example, the user may elect to leave the media and attachments on the host system 15 or to archive the project by moving the media and attachments from the host system 15 to an archiving system. Still further, the user may elect to removes the media and attachments from the host system 15. A metadata screen may also be implemented to allow a user to define and create user-defined metadata fields. This screen may be used to create the metadata fields that are seen on orders. The metadata field name, data type (text or number), field size, and whether it is a required field can all be selected from the metadata screen and corresponding linked pages.

An Orders screen may be used for creation, modification, approval, and status tracking of orders. The Order screen and its linked pages allow for entry of project, advertiser, attachments and routing information when initiating the order. The order screen may also allow the user to select what will happen to the order when it is closed. Further, the order screen and its linked pages may allow for searching of orders, finding the order status, etc.

The attachments and metadata values to be added and modified for an order may also be entered through the order screen and its linked pages. Easy entry of standard attachment types may be provided. For example, a drop-down box or the like may be used to select whether the attachment is a 1) Storyboard, 2) Script, 3) Affidavit, 4) Cover Letter, 5) Media, and 6) Other. Further, any such entry page should provide for a file browsing utility to allow easy entry of the file location of the attachment on the local disk. A “Name” field may be provided to identify the name with which the attachment will be referred to during the routing process. Further, the page may allow the user to enter a description of the attachments and to identify whether the attachment will be sent under separate cover. If sent under separate cover the attachment will be provided to the routing Business Partners via another method. This allows for attachments that are not in electronic format.

The foregoing pages are merely exemplary. Those skilled in the art will readily be able to implement the foregoing pages of the system as well as to design other pages with various fields organizations that implement the functions discussed above.

Numerous modifications may be made to the foregoing system without departing from the basic teachings thereof. Although the present invention has been described in substantial detail with reference to one or more specific embodiments, those of skill in the art will recognize that changes may be made thereto without departing from the scope and spirit of the invention as set forth in the appended claims.

1. An automated media content submission and distribution network for use in clearing television network advertisements comprising:
a job submission system disposed at a submitting organization and adapted to submit a clearance job including digital job content corresponding to one or more items selected from the group consisting of advertising substantiation documentation, advertising scripts, advertising storyboards, pre-production advertising video and/or audio, post-production advertising video and/or audio, and client job messages;
a job access system disposed at a clearance organization involved in clearing the television network advertisements, the job access system including software for reviewing digital content of the type submitted by the job submission system;
a host system including a content management system adapted to receive the digital job content from the job submission system and to provide the clearance organization with access to the digital job content through the job access system.

1. A media content submission and clearance communication network comprising:
a first client system adapted to allow a first organization to provide login data over the communication network for authentication of the identity of the first organization,
job access data for identifying at least a second organization that is to be given access to job content provided by the first organization,
the job content including one or more items selected from the group consisting of advertising substantiation documentation, advertising scripts, advertising storyboards, pre-production advertising video and/or audio, post-production advertising video and/or audio, and client job messages;
a second client system disposed at the second organization, the second client system adapted to allow entry of login data over the communication network for authentication of the identity of the second organization;
a host system including a content management system adapted to receive the login information and digital job content from the first client system and to provide the second organization with access to the digital job content received from the first client system based on the login data provided through the second client system.

1. A method for clearing television advertisement content comprising:
submitting a clearance job over an electronic communications network, the clearance job including digital job content corresponding to one or more items selected from the group consisting of advertising substantiation documentation, advertising scripts, advertising storyboards, pre-production advertising video and/or audio, post-production advertising video and/or audio, and client job messages, the digital job content further comprising data identifying one or more clearance organizations that are to be granted access to the one or more items of the digital job content;
receiving the digital job content over the electronic communications network and electronically identifying the one or more clearance organizations that are to be given access to the digital job content;
granting access to the one or more items of the digital job content to the one or more clearance organizations over the electronic communications network.
